(19) United States
(12) Patent Application Publication
(10) Pub. No.: US 2007/0103811 A1
(43) Pub. Date: May 10, 2007

(54) FILTRATION ARRANGMENT FOR ELECTRONIC ENCLOSURE

(76) Inventor: Jason R. Olszewski, Eden Prairie, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 11/530,887

(22) Filed: Sep. 11, 2006

Related U.S. Application Data
(60) Provisional application No. 60/716,040, filed on Sep. 9, 2005.

(51) Int. Cl. G11B 33/14

(52) U.S. Cl. 360/97.02

(57) ABSTRACT

A filtration arrangement for electronic enclosures such as hard disk drives. A wall is formed around the circumference of at least a portion of a rotating disk. A channel is formed between a surface of the wall and the housing of the electronic enclosure, and a filter is located within the channel. When the disk rotates, currents are generated within a gas contained in the electronic enclosure. The gas enters the channel, minimizing contact between the contaminants entrained within the ga5 and the disk. The gas must pass through the filter before exiting the channel, minimizing the amount of gas that bypasses the filter.

### PRIORITY

This application claims the benefit of U.S. Provisional Patent Application Ser. No. 60/716,040, filed Sep. 9, 2005, which application is hereby incorporated by reference in its entirety.

### TECHNICAL FIELD The present disclosure relates to filtration for electronic enclosures, and in particular, relates to filtration and the removal of contaminants from within hard disk drives.

### BACKGROUND

Hard disk drives and other electronic equipment are often placed within enclosures to provide a clean environment that is necessary for optimal operation of the equipment. For example, hard disk drives normally contain at least one inflexible platter or disk coated with magnetic material that is positioned within an enclosure. The disk is rapidly spun and a magnetic read/write head “flies” a few microns above the disk. It is desirable to position the head as close as possible to the disk without touching it order to provide a high capacity drive.

Contaminants, including particles, gases, and liquids within the hard disk drive enclosure, can act to reduce the efficiency and longevity of the hard drive. These contaminants can gradually damage the drive, cause deterioration in performance, and in certain situations can even cause sudden and complete drive failure. Contaminants can, for example, enter the electronic enclosure from an external manufacturing environment, which can contain certain contaminants, and materials incorporated into the disk drive which give off particulates and gases.

One particular concern regarding electronic enclosures is that contaminants from outside of the electronic enclosure can enter the enclosure. When a disk drive is in operation, the air in the drive enclosure heats up which creates an increase in air pressure in the enclosure, and when a disk drive ceases to be in operation, the air in the enclosure cools down and creates a decrease in pressure in the enclosure. As a result of these changes in pressure, some disk drives have a breather hole to allow air to move into and out of the drive to equalize the pressure inside the drive with atmospheric pressure.

If particulate or chemical contaminants are present in the exchanged air, the interior of the enclosure will become contaminated. In one arrangement that may be employed to limit the potential for contaminants being introduced from outside of the drive is to configure the drive so that it is completely sealed from the atmosphere. In such an arrangement, the interior of the drive is typically filled with an inert, low molecular weight gas, such as helium. The inert, low molecular weight gas expands less than air for a given temperature increase, so that the pressure inside the drive does not build excessively with temperature increases.

However, even where the electronic enclosure is sealed, organic vapors and other contaminants can be generated inside electronic enclosures during normal operating conditions. For example, when the temperature exceeds 150° F., organic acids and organic vapors can be formed that damage electronic components. Such temperatures can be achieved by simply leaving the computer in the trunk of a car on a hot day. It is important that these contaminants generated within the enclosure be efficiently captured or removed in order to prevent deterioration of the electronic equipment.

The rotation of the disk within a disk drive tends to generate gas flow currents within the drive. In some applications, a filter is placed within these currents. However, the filter in such an arrangement is only exposed to a portion of the total gas current. Moreover, when an electronic enclosure is sealed and filled with an inert, low molecular weight gas, the lower mass density of the gas cause the I current to have lower inertia than a similar current of air. Because a filter necessarily restricts gas flow to some extent, a gas flow of low molecular weight, low inert gas will not tend to flow as readily through a filter as air, and may instead be prone to flowing around the filter. In practice, this results in lower contaminant removal effectiveness.

Therefore, a need exists for a filtration arrangement for use in an electronic enclosure, and in particular, a filtration arrangement that improves filtration performance in sealed and unsealed electronic enclosures.

### SUMMARY

The present disclosure is directed to a filtration arrangement for use inside of an electronic enclosure, such as a hard disk drive enclosure containing a rotating disk. The filtration arrangement provides filtration of gases circulating within the electronic enclosure. The filtration arrangement generally comprises a channel formed about a portion of the periphery of a rotating member, such as a disk. Gas currents generated by the rotating member enter the channel at an upstream aperture.

While in the channel, the gas current and any contamination entrained within the current is contained within the channel and is isolated from the rotating disk. The gas current exits the channel through a filter placed at a downstream aperture of the channel. The channel limits the ability of the gas to bypass the filter. The above summary is not intended to describe each embodiment of the present disclosure.

### DESCRIPTION OF THE DRAWINGS

FIG. 1 is a top cross-sectional view of a filter arrangement according to present disclosure.

FIG. 2 is a side cross-sectional view of the filter arrangement of FIG. 1 along line A-A in FIG. 1.

FIG. 3 is a perspective, sectioned view of the filter arrangement of FIG. 1 taken along line A-A in FIG. 1.

### DETAILED DESCRIPTION

The present disclosure is directed to a filter arrangement for use inside an electronic enclosure, such as a hard disk drive enclosure containing a rotating disk. The filter arrangement provides filtration of gases circulating within the enclosure. Referring now to the figures, an embodiment of the invention is described detail with reference to the drawings, wherein like reference numbers represent parts and assemblies throughout the several views.

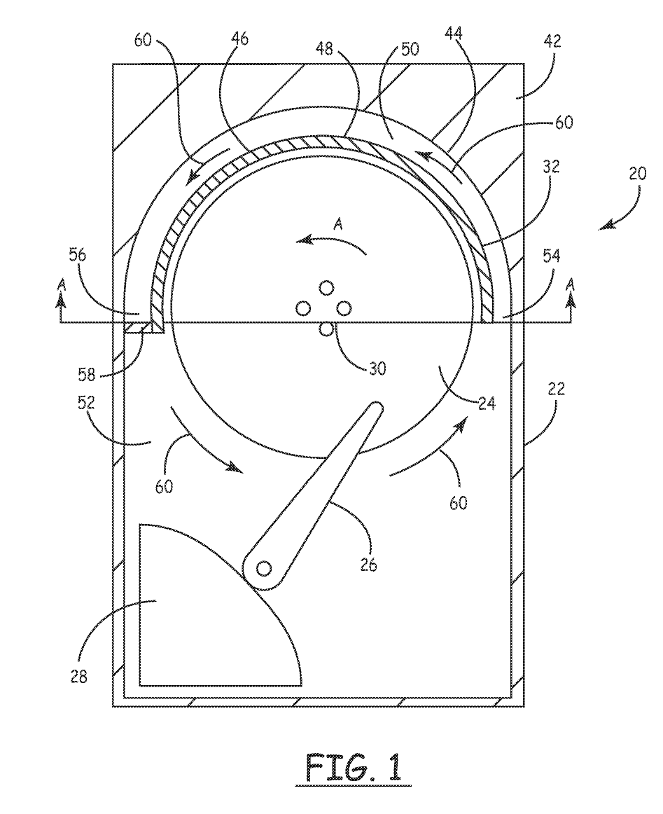

Referring to FIG. 1, a top cross-sectional view of a disk drive 20 is shown. Disk drive 20 includes a housing 22, a magnetic disk 24, a magnetic read/write head 24 around at least a portion of the circumference of disk 24. In one embodiment, wall 32 extends around about half of the circumference of disk 24. In another embodiment, wall 32 extends around more than half of the circumference of disk 24. In yet another embodiment, wall 32 extends around less than half of the head 26, and a magnet 28.

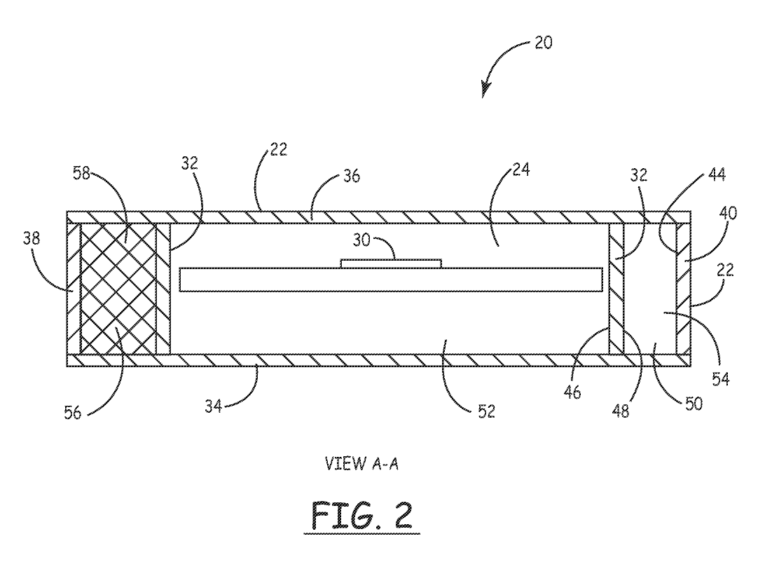

A gas 52 is contained within housing 22 and generally entrained contaminants. Contaminants within gas 52 may include organic such as in direction A indicated in FIG. 1, by connection to a drive motor (not shown) through hub 30. Magnetic read/write head 26 is positioned in close proximity to magnetic disk 24, but is not in contact with magnetic disk 24. As shown in the cross-sectional view of disk drive 20 in FIG. 2, housing 22 includes bottom region 34, top region 36, first side region 38, and second side region 40. As see in FIG. 1, housing 22 defines an end region 42 that includes a curved side 44 defining a relatively uniform clearance with disk 24 around at least a portion of the circumference of disk 24. In another embodiment, curved surface 44 is formed separately from housing 22. Housing 22, magnetic disk 24, magnetic read/write head 26, magnet 28, and hub 30 are constructed and operated in a manner known to those of skill in the art. Wall 32 is located between curved surface 44 and magnetic disk 24 includes embodiments of wall 32 are possible. In the embodiment shown in FIGS. 1 and 2. Wall 32 defines a first surface 46 that faces toward disk 24 and a second surface 48 that faces toward curved surface 44. Wall 32 is configured so that the clearance with the circumference of disk 24 is relatively shall but wall 32 does not touch disk 24. In the embodiment shown in FIGS. 1, 2 and 3, wall 32 extends between bottom region 34 and top region 36 of housing 22. In another embodiment, wall 32 extends partially between bottom region 34 and to region 36 of housing 22.

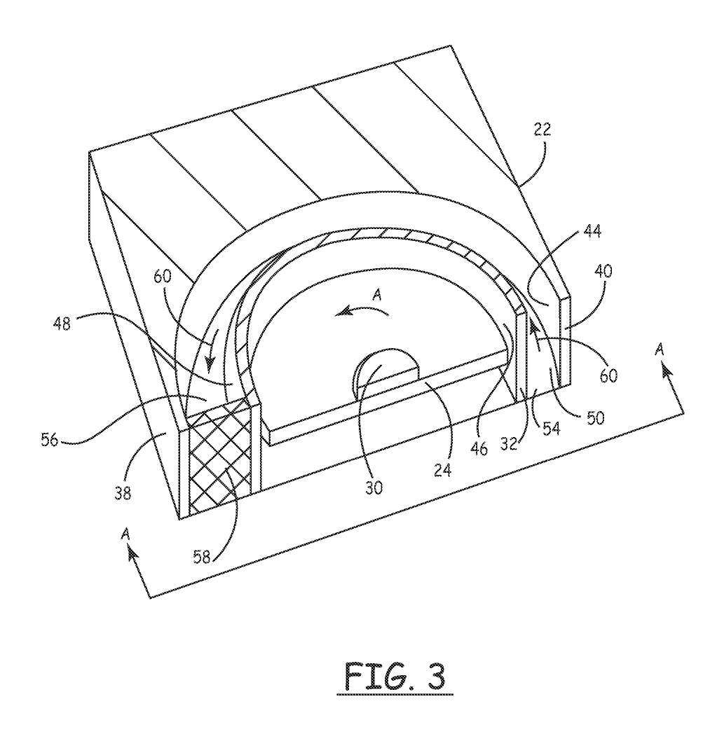

Channel 50 is formed between second surface 48 of wall 32 and curved surface 44 of housing 22. Channel 50 defines an entry aperture 54 and an exit aperture 56. Channel 50 may comprise many different embodiments. In the embodiment shown in FIGS. 1, 2, and 3, channel 50 is bounded by bottom region 34 and top region 36 of housing 22. In the embodiments shown in FIGS. 3, curved surface 44 and second surface 48 are generally separated by equal distances, forming a channel 50 of uniform width. However, surfaces 44 and 48 may be configured to be separated by a variable distance, forming a channel 50 of varying width.

Filter 58 is located within channel 50, Filter 58 may be located anywhere in channel 50. In the embodiment shown in FIGS. 1, 2, and 3, filter 58 is located proximate to discharge aperture 56 of channel 50. Filter 58 may also comprise 1 any different embodiments. In one embodiment, filter 58 comprises an activated carbon filter. In another embodiment, filter 58 comprises polytetrafluoroethylene (PTFE).

In yet another embodiment, filter 58 comprises a dessicant. In a further embodiment, filter 58 may comprise an adsorbent recirculation filter (ARF). Another embodiment of filter 58 is a solid recirculation filter (SRF). Filter 58 preferably forms a close fitting connection with at least curved surface 44 and second surface 48. In operation, when magnetic disk 24 rotates in direction A, the rotation tends to induce currents 60 within the gas 52 present within disk drive 20. Currents 60 of gas 52 proceed in the same general direction as the rotation of magnetic disk 24. The velocity of currents 60 is related to the velocity of the surface of magnetic disk 24 at the circumference of magnetic disk 24, currents 60 will also tend to be greatest. Because for a given rate of rotation of disk 24, the greatest velocity of disk 24 will be near the circumference of magnetic disk 24. As currents 60 of gas 52 flow through channel 50, they will encounter filter 58 proximate to discharge aperture 56. Because gas 52 is constrained within channel 50, gas 52 must pass through the filter 58 before exiting through discharge aperture 56 of channel 50. This has the advantage of minimizing the amount of gas 52 that can bypass or flow around filter 58, and thereby increases the effectiveness of filter 58 in removing contaminants from gas 52.

We claim:

1. An electronic enclosure comprising:
a rotating disk;
a housing substantially surrounding the disk;
a channel in the housing proximate the disk; and
and a filter element positioned proximate the channel.
